(19) United States
(12) Patent Application Publication
(10) Pub. No.: US 2006/0138736 A1
(43) Pub. Date: Jun. 29, 2006

(54) Suspension assembly

(75) Inventors: Brett John Clarebrough, Roseville, New South Wales (AU); Douglas Gordon Hyde, Roseville New South Wales (AU)

Correspondence Address: OSTROLENK FABER GERB & SOFFEN, 1180 AVENUE OF THE AMERICAS, NEW YORK, NY, 100368403, US

(73) Assignee: Under Par Pty Ltd, Roseville, New South Wales (AU)

(21) Appl. No.: 10/531,970

(22) PCT Filed: Oct. 21, 2003
(86) PCT No.: PCT/AU03/01394

§ 371 Date: Apr. 20, 2005

(30) Foreign Application Priority Data
Oct. 21, 2002 (AU) 2002952178

(51) Int. Cl. B62B 1/00

(52) U.S. Cl. 280/47.26

(57) ABSTRACT

A suspension assembly adapted to be fitted to a manually drawn two wheeled golf buggy includes a chassis mount typically arranged to be mounted into the existing axle tube of a conventional golf buggy by way of a spigot, a scissor link in the form of a chassis mount arm extending from the chassis mount and a wheel mount arm pivotally connected together by hinge arrangement, and a wheel mount sleeve adapted to receive the stub axle of a golf buggy wheel. A compression spring is provided between the chassis mount and the wheel mount allowing for damp resilient movement between the wheel of the golf buggy and the chassis. Variations are also described where the suspension assembly is provided as an integral part of the golf buggy chassis.

### FIELD OF THE INVENTION

The present invention relates to manually operated (non-motorised) golf buggies of the type used to carry a player's golf bag around the course.

### BACKGROUND OF THE INVENTION

Golf buggies generally have a chassis with two wheels arranged so that it can cradle a golf bag and support itself in a stable, upright position. To move the buggy around the course, the chassis is rotated about the axis of the wheels so that the supporting section of the chassis lifts off the ground thus freeing the wheels to roll as it is drawn along behind or pushed by the player.

Unfortunately, irregularities in the ground surface are translated directly to the golf buggy handle. This can make manoeuvring difficult or uncomfortable for the player. Ground irregularities will also cause the clubs in the golf bag to rattle against each other with potentially damaging impact. Such rattling also generates an appreciable level of noise which can be distracting and disruptive to other players on the course.

### SUMMARY OF THE INVENTION

Accordingly in one aspect the present invention provides a suspension assembly adapted to be fitted to a golf buggy, including:

a chassis mount arranged to mount the assembly to the chassis of the buggy;

a wheel mount arranged to support a wheel of the buggy; and

a suspension linkage extending between the chassis mount and the wheel mount.

In a further aspect the present invention provides a golf buggy having a chassis and a pair of wheels for travel across a ground surface, said buggy including a pair of suspension assemblies arranged one to each wheel;

each suspension assembly including a chassis mount arranged to mount the assembly to the chassis of the buggy,

a wheel mount arranged to support a wheel of the buggy; and

a suspension linkage extending between the chassis mount and the wheel mount.

Preferably the suspension linkage includes a hinged scissor link supporting relative movement of the chassis mount and the wheel mount against a resilient medium.

Preferably the scissor link includes a chassis mount arm extending from the chassis mount, a hinge arrangement at the distal end of the chassis mount arm, and a wheel mount arm extending from the hinge arrangement to the wheel mount.

Preferably the resilient medium comprises a spring extending between the chassis mount and the wheel mount.

In one form of the invention the suspension assembly is adapted to be retrofitted to an existing (prior art) golf buggy, and wherein the chassis mount includes a spigot adapted to be inserted into an axle mounting tube in a conventional golf buggy chassis to mount the suspension assembly to that chassis.

Preferably the wheel mount includes a sleeve adapted to receive a stub axle on which a corresponding wheel of the golf buggy is rotatably mounted.

Using the present invention, it is possible to provide golf buggies with a simple yet surprisingly effective suspension system. The simplicity of its design allows the system to be relatively inexpensive, aesthetically acceptable and easily incorporated into the manufacture of buggies, or as an after market retrofit. The cushioned ride provided by the suspension significantly reduces the potentially damaging rattling of the clubs in the bag. The erratic or “jerky” movements of the buggy handle as it is drawn over rough ground is also substantially diminished. In turn, the ease and comfort of manoeuvring the buggy is enhanced.

### BRIEF DESCRIPTION OF THE DRAWINGS

Preferred embodiment of the invention will now be described, by way of example only, with reference to the accompanying drawings in which:

FIG. 1 shows a typical example of a manually drawn prior art golf buggy together with a golf bag lifted from the bag craddle for clarity;

FIG. 2 is a front elevation of the suspension assembly according to the present invention;

FIG. 3 is a side elevation of the suspension assembly of FIG. 2; and

FIG. 4 is a perspective view of the suspension assembly shown in FIGS. 2 and 3.

### DETAILED DESCRIPTION OF THE PREFERRED EMBODIMENTS

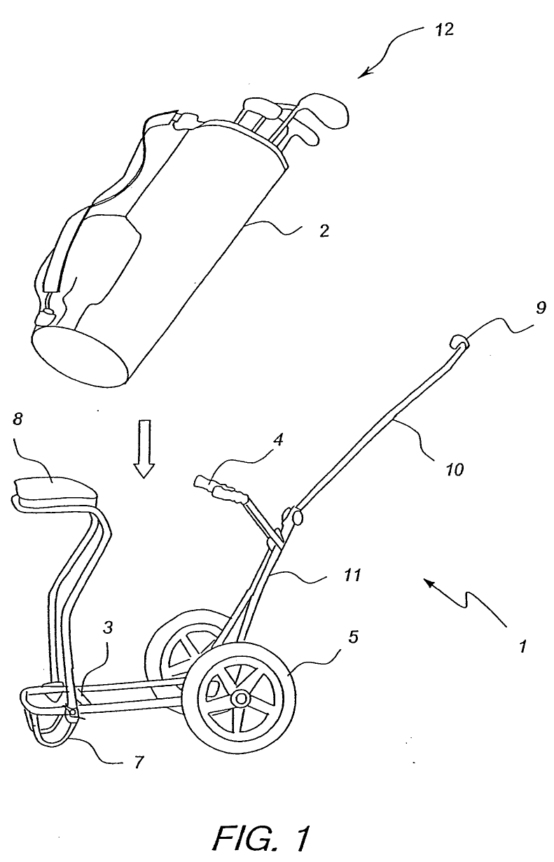

The golf buggy 1 shown in FIG. 1 is typical of most manually drawn golf buggies. The golf bag 2 is craddled in the buggy against a bag support 3 and craddle arms 4. The bag 2 is craddled so that its weight allows the buggy to stay upright and supported on the wheels 5 and 6 as well as the support 7. Often, a seat 8 is also provided for the comfort of the player.

In use, the player draws the buggy along using the handle 9. The length of the handle stem 10 is designed so that the chassis 11 of the buggy 1 rotates about the axis of the wheels to disengage the support 7 from the ground.

The wheels 5 and 6 are rigidly mounted to the chassis 11 and any shocks or vibrations caused by irregularities in the ground surface are transmitted directly to the golf bag 2 and the handle 9. This can shake the bag 2 and cause the clubs 12 to impact with each other and the interior of the bag. This is potentially damaging to the clubs and generates a significant level of noise.

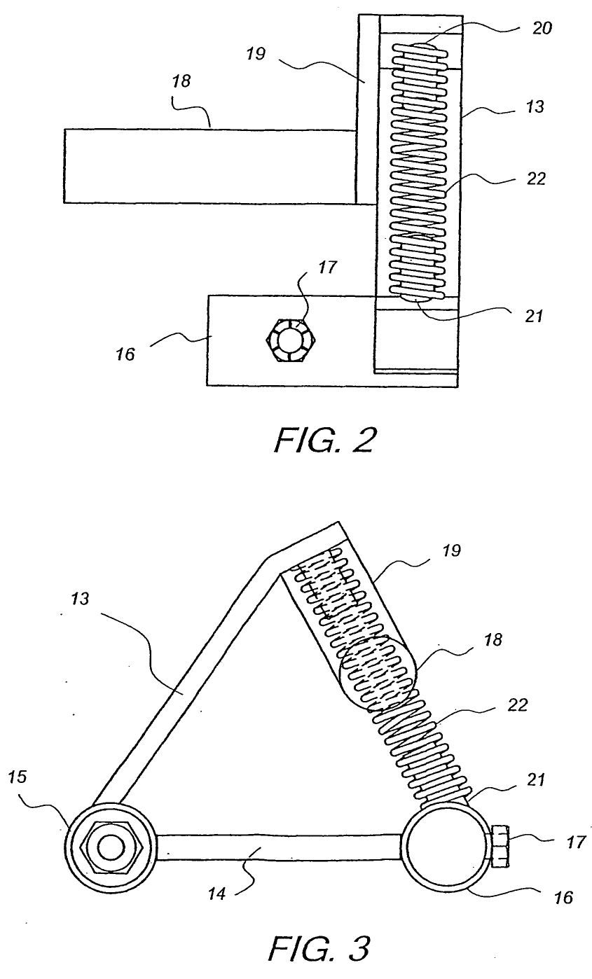

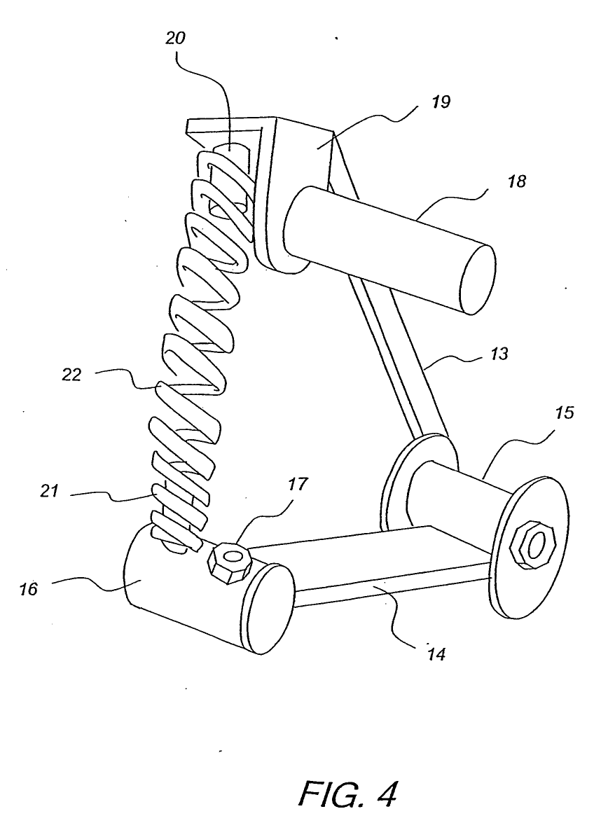

The shock loading and vibrations caused by ground irregularities will also produce erratic and “jerky” forces on the handle 9. This can make the buggy 1 difficult and uncomfortable to use and manoeuvre. Incorporating the suspension assembly shown in FIGS. 2, 3 and 4 provides the buggy 1 with a smoother operation that sustantially reduces the vibration and impact problems discussed above.

Referring to FIGS. 2, 3 and 4, the suspension assembly is shown in isolation from the chassis 11 and wheels 5 or 6. The assembly uses a scissor linkage with a chassis mount arm 13 connected to a wheel mount arm 14 via hinge arrangement 15 for relative angular movement. At the distal end of the wheel mount arm is a wheel mount sleeve 16 with an internal diameter sized to receive the stub axle of the wheels 5 or 6. Locking bolt 17 secures the stub axle within the sleeve 16.

Chassis mounting bar or spigot 18 is sized so that it can be received in the original wheel mounting sleeve of the chassis 11. End plate 19 connects the chassis mounting bar 18 to the chassis mount arm 13. Spigots 20 and 21 are welded to the chassis mount arm and wheel mount arms respectively. Compression spring 22 extends between the spigots. The internal diameter of the spring 22 is conveniently sized for engaging the spigots 20 and 21 with an interference fit.

Although the suspension assembly has been described as incorporating a resilient element in the form of a compression spring 22 it will be appreciated that any resilient element that provides a biasing force opposing any suspension travel of the wheel away from an equilibrium position could be used. It is generally advantageous if the biasing force is proportional to the suspension travel. In place of a compression spring it will be appreciated that the resilient element could for example comprise a polymer or rubber suspension hanger, a gas filled bladder or even be differently arranged such that the suspension linkage is provided by the elastic deformation of a generally horizontal strut cantilevered from the wheel mount. It will also be appreciated that various embodiments of the invention may also include a damping element to reduce oscillations about an equilibrium position.

The impact and vibration of the wheels when travelling over rough ground can be substantially absorbed and accommodated through the scissor action of the suspension assembly against the restoring force of the spring 22. The suspension travel cushions golf bag 2 and the handle 9 against the impact of irregularities in the ground giving the buggy an appreciably smoother and quieter overall operation. This is not only beneficial for the owner of the buggy, but also other players on the course that may otherwise be distracted by the noise from excessive club rattle.

The present invention has been described herein by way of example only. Ordinary workers in this field will readily recognise many variations and modifications which do not depart from the spirit and scope of the broad inventive concept. For example, telescopically engaging sleeves surrounding the spring may be used instead of the scissor linkage, polymer material or compressible gas may be used for the resilient element and in more complex versions, a mechanical damper can be included for damped suspension travel. The broad inventive concept may also encompass active suspension whereby a transducer senses the vertical orientation of the buggy and feeds or drains gas from air bag suspension on each wheel.

1. A suspension assembly adapted to be fitted to a golf buggy, including a chassis mount arranged to mount the assembly to the chassis of the buggy, a wheel mount arranged to support a wheel of the buggy, and a suspension linkage extending between the chassis mount and the wheel mount.

2. A suspension assembly as claimed in claim 1, wherein the suspension linkage includes a hinged scissor link supporting relative movement of the chassis mount and the wheel mount against a resilient medium.

3. A suspension assembly as claimed in claim 2, wherein the scissor link includes a chassis mount arm extending from the chassis mount, a hinge arrangement at the distal end of the chassis mount arm, and a wheel mount arm extending from the hinge arrangement to the wheel mount.

4. A suspension assembly as claimed in claim 3, wherein the resilient medium comprises a spring extending between the chassis mount and the wheel mount.

5. A suspension assembly as claimed in claim 1, wherein the chassis mount includes a spigot adapted to be inserted into an axle mounting tube in a conventional golf buggy chassis to mount the suspension assembly to that chassis.

6. A suspension assembly as claimed in claim 1, wherein the wheel mount includes a sleeve adapted to receive a stub axle on which a corresponding wheel of the golf buggy is rotatably mounted.

7. A golf buggy having a chassis and a pair of wheels for travel across a ground surface, said buggy including a pair of suspension assemblies arranged one to each wheel, each suspension assembly including a chassis mount arranged to mount the assembly to the chassis of the buggy, a wheel mount arranged to support a wheel of the buggy, and a suspension linkage extending between the chassis mount and the wheel mount, the suspension linkage being adapted to allow relative movement between the wheel mount and the chassis mount in response to travel across irregularities in the ground surface.

8. A golf buggy as claimed in claim 7, wherein the suspension linkage includes a hinged scissor link supporting relative movement of the chassis mount and the wheel mount against a resilient medium.

9. A golf buggy as claimed in claim 8, wherein the scissor link includes a chassis mount arm extending from the chassis mount, a hinge arrangement at the distal end of the chassis mount arm, and a wheel mount arm extending from the hinge arrangement to the wheel mount.

10. A golf buggy as claimed in claim 9, wherein the resilient medium comprises a spring extending between the chassis mount and the wheel mount.
